(19) United States
(12) Patent Application Publication
(10) Pub. No.: US 2019/0144065 A1
(43) Pub. Date: May 16, 2019

(54) MOTOR SCOOTER THAT CAN BE FOLDED UP

(71) Applicant: UJET S.A., Leudelange (LU)

(72) Inventors: Patrick David, Blaustein (DE); Mariana Grehl, Staig (DE); Timo Speidel, Ulm (DE)

(21) Appl. No.: 16/306,952

(22) PCT Filed: Jun. 6, 2017
(86) PCT No.: PCT/EP2017/063666

§ 371 Date: Dec. 4, 2018

(30) Foreign Application Priority Data
Jun. 6, 2016 (DE) 10 2016 110 447.7

(51) Int. Cl. B62K 15/00; B62H 1/04; B62J 25/00; B62K 25/00; B62K 21/26

(52) U.S. Cl. CPC B62K 15/006; B62H 1/04; B62J 25/00; B62K 2204/00; B62K 21/26; B62K 2202/00; B62K 25/005

(57) ABSTRACT

The invention relates to a collapsible vehicle (10), in particular a collapsible motor scooter, having a rear frame part bearing a seat unit (70) and at least one rear wheel (11′) and a front frame part (61) bearing a steering unit (19) and at least one front wheel (11). According to the invention, the front frame part (61) and the rear frame part (60) are connected to one another via an acentric pivot joint (80) such that during collapsing of the vehicle (10), at least one frame part (60, 61) is pivotable such that the at least one front wheel (11) and the at least one rear wheel (11′) are arranged adjacent to one another, in particular congruently adjacent to one another.

The invention relates to a collapsible vehicle, in particular a collapsible motor scooter, having a rear frame part bearing a seat unit and at least one rear wheel and a front frame part bearing a steering unit and at least one front wheel, according to claim 1.

Collapsible electric motor scooters are known from the prior art. Reference is made solely by way of example to DE 10 2006 002 912 B4. Corresponding electric motor scooters or motorized two-wheeled vehicles typically have a vehicle body and two wheels, wherein one of the wheels is driven via an electric drive.

Collapsible electric motor scooters have heretofore proven to be uncomfortable during driving. This is to be attributed, for example, to the relatively small-dimensioned wheels and the also small-dimensioned seat surfaces and steering unit structures.

Proceeding from this prior art, it is the object of the present invention to provide a collapsible vehicle, in particular a collapsible motor scooter, which is easily collapsible, on the one hand, and has the accustomed comfortability of standard motorcycles, in particular two-wheeled vehicles, on the other hand.

This object is solved according to the invention with respect to the collapsible vehicle, in particular with respect to a collapsible motor scooter, by the subject matter of claim 1.

Advantageous and expedient embodiments of the collapsible vehicle according to the invention are specified in the dependent claims.

In particular, the object is solved by a collapsible vehicle, in particular by a collapsible motor scooter, having a rear frame part bearing a seat unit and at least one rear wheel and a front frame part bearing a steering unit and at least one front wheel, wherein the front frame part and the rear frame part are connected to one another via an acentric pivot joint such that during the collapsing of the vehicle, at least one frame part is pivotable such that the at least one front wheel and the at least one rear wheel are arranged adjacent to one another, in particular congruently adjacent to one another.

Accordingly, the vehicle comprises at least two frame parts, which are articulated with one another, wherein collapsing of the two frame parts is possible such that the front wheel and the rear wheel can be moved in the collapsed state into a position such that these two wheels are arranged standing adjacent to one another. Standing adjacent to one another refers in this context to the relative position in relation to one another. It is entirely possible that the two wheels do not touch in the collapsed state. Arranged congruently adjacent to one another is to be understood as such a position of the wheels in which the circular cross-sectional areas of the wheels are arranged adjacent to one another, wherein the cross-sectional areas are preferably not tilted in relation to one another. The rear wheel is preferably arranged parallel and congruent to the front wheel in the col-lapsed state of the vehicle.

One essential advantage of such a collapsed vehicle is that the collapsible vehicle is collapsible with little application of force, wherein standard size motor scooter wheels do not have to be dispensed with.

The collapsible vehicle preferably has a stand device, which comprises at least two side stands. Two side stands are to be understood as two legs which are un-foldable laterally from the collapsible vehicle. The stand device preferably comprises at least one left and at least one right side stand. Left and right are to be understood as the direction specifications originating from the longitudinal axis of the vehicle, in particular originating from a center strut of the frame of the vehicle.

The at least two side stands are preferably arranged asymmetrically in relation to one another and have different lengths. An asymmetric arrangement is to be understood as such an arrangement of at least two side stands, which is intended to form the unfolding angles of the side stands differently. The side stands can also be formed differently with respect to their relative position in relation to the longitudinal axis.

The side stands particularly preferably have different lengths. The left side stand, wherein left is to be understood as left in the travel direction, is preferably shorter than the right side stand.

Furthermore, the stand device, in particular the shorter side stand of the at least two side stands, can be connected to a spring, which can be tensioned upon unfolding of the stand device, in particular upon unfolding of one/the shorter side stand. Such a spring has the effect that an unfolded side stand is folded in or pivoted in automatically when the collapsible vehicle is lifted.

The at least two side stands are preferably mechanically coupled to one another. Therefore, the at least one further side stand can also be actuated by actuating one side stand. The mechanical coupling is implemented, for example, via a linkage. The shorter side stand is preferably formed as the side stand to be actuated. Therefore, without additional further effort, the longer side stand can be unfolded in the same step by actuating the shorter side stand.

In the case of coupling of the stand device, in particular the shorter side stand, to a spring, and mechanical coupling of the shorter side stand to the longer side stand at the same time, the longer side stand can also be folded in by automatic folding in of the short stand.

The two frame parts, i.e., the front frame part and the rear frame part, are locked and/or latched with one another at least in the folded-out state by a detachable mechanism, in particular a detachable catch mechanism. By unlocking or unlatching the mechanism, in particular the catch mechanism, the two frame parts can be collapsed as a result of the acentric pivot joint. In particular, the front frame part is turned or pivoted in the direction of the rear frame part about the acentrically formed pivot joint. By unlocking or unlatching the (catch) mechanism, the two frame parts can be pivoted about the axis of rotation of the acentrically formed pivot joint. The axis of the pivot joint extends substantially perpendicularly to the support surface on which the vehicle, in particular the motor scooter, stands.

An acentric pivot joint is to be understood as such a pivot joint which is not formed on the longitudinal axis of the vehicle. The longitudinal axis is preferably formed as part of a plane of section which extends in the longitudinal direction of the vehicle and approximately halves the vehicle in a top view. The pivot joint is formed spaced apart from the longitudinal axis of the vehicle. The axis of rotation of the pivot joint extends substantially perpendicular to the support surface on which the vehicle stands or is held vertically, in particular with folded-in stand device. The pivot joint is preferably formed in the region of the footrest (surface) of the vehicle, in particular the motor scooter.

The pivot joint is preferably formed in the sense of a hinge joint, in particular as a hinge joint. In particular, a joint pin is formed, which connects at least one plate section of the front frame part and at least one plate section of the rear frame part to one another so they are rotatable. The joint pin determines the axis of rotation of the pivot joint.

It is possible that a mechanism locking the front frame part and the rear frame part in the unfolded state, which in particular comprises a locking hook, can be actuated by a pedal, wherein the pedal is preferably formed as a section of a footrest of the vehicle. A footrest of the vehicle is to be understood in particular as a step support. The footrest of the vehicle relates, for example, to the footrest surface of a motor scooter.

The mentioned pedal is therefore preferably formed as a foot pedal. By actuating the pedal, the locking mechanism can be actuated, in particular unlocked. The locking mechanism is preferably formed as part of the pedal. In particular, a locking hook or a locking contour can be formed on the pedal. This has the advantage that the locking mechanism consists of relatively few components and is moreover simple to actuate. Large forces do not have to be applied to actuate the mechanism.

In a further embodiment of the invention, it is possible that the pedal is unlockable by means of a side stand. The pedal, in particular in the case in which the pedal is formed as a section of a footrest of the vehicle, preferably cannot be actuated in every state. If the vehicle is in a traveling state, it is hazardous to actuate the pedal. An unintentional collapse of the vehicle could occur during travel. In particular in the case of a traveling motor scooter, it would be disadvantageous if the pedal, which is formed in particular as a foot pedal, could be actuated at any time.

The pedal can preferably only be actuated in a parked state of the vehicle. A parked state of a vehicle, in particular a motor scooter, is the state of the vehicle given by unfolding at least one stand. It is accordingly advantageous if the pedal is unlockable by means of a side stand. For this purpose, the side stand has a stop which presses on the pedal in the folded-in state of the side stand, so that the pedal itself cannot be pressed or actuated. If the side stand is unfolded, the stop is preferably also moved. In particular, the stop is moved away from the pedal upon unfolding of the side stand, so that the pedal itself can be moved or actuated.

In an alternative embodiment of the invention, it is possible that the pedal is locked by means of a side stand, wherein the side stand has a hook-like element. The hook-like element can engage in a pin-like element of the pedal and/or the vehicle frame. The hook is preferably hooked in the pin in the folded-in or folded-up state of the side stand. If the side stand is folded out or folded away laterally, the hook can be disengaged from the locked state. The pin (of the pedal) is released in the folded-out state of the side stand, so that the pedal can first be actuated in the parked state of the collapsible vehicle.

In one particularly preferred embodiment of the invention, one/the locking hook is formed on the pedal, wherein a locking pin or such a locking element is preferably formed on the front frame part, in which the locking hook or a locking contour can engage.

After the complete unlocking of the mechanism, the front frame part can subsequently be pivoted in the direction of the rear frame part. The pivot takes place about the axis of rotation of the pivot joint.

One/the longer side stand of the stand device particularly preferably determines the pivot direction of the front frame part in the direction of the rear frame part.

In addition, it is possible that the stand device, in particular one of the side stands, particularly preferably the longer side stand, has an interfering contour, so that the front wheel can be pivoted along the interfering contour in the direction of the rear wheel. The interfering contour furthermore has the effect that the front wheel cannot entangle with other parts of the collapsible vehicle during the collapsing procedure.

In one embodiment, the front wheel and the acentric pivot joint can be arranged in relation to one another such that the front wheel is pivotable along a circular path about the acentric pivot joint. Because the front wheel follows a circular path, the driver can collapse or unfold the vehicle in a simple manner.

In one embodiment, the rear wheel, the stand device, and at least a section of one/the footrest, in particular one/the pedal, can be arranged and designed for in particular forming the only support points of the vehicle at least in sections during collapsing of the vehicle, in particular during a first rotation phase. In principle, at least three support points are necessary to securely hold a vehicle. During a first rotation phase, these can be formed by the front wheel, the rear wheel, and the stand device.

In a second rotation phase, which in particular follows the first rotation phase, the rear wheel, the stand device, and at least one section of one/the footrest, in particular one/the pedal can be arranged and designed for forming in particular the only support points of the vehicle, in particular during the collapsing.

The support points of the vehicle can thus change during the collapsing and/or the unfolding. If, as during the second rotation phase, the front wheel does not form a support point, it can be freely pivoted, so that it can be placed parallel to the rear wheel, for example, to lock the front wheel with the rear wheel.

In one embodiment, the stand device can be connected to the front frame part, in particular via a stand joint. When the stand device is fastened on the front frame part, the footrest, which can be arranged on the rear frame part, can then act as a support point.

The acentric pivot joint is preferably formed on the side of the vehicle, in particular on the side of the footrest of the vehicle, which faces toward the longer side stand. Preferably, both the acentrically formed pivot joint and also the longer side stand are formed on the same side, i.e., left or right of the longitudinal axis of the vehicle.

In the collapsed state of the vehicle, the axle of the front wheel is connected or connectable to the axle of the rear wheel by means of a wheel locking unit. In the collapsed state of the vehicle, in particular in the collapsed state of the motor scooter, the at least two wheels are arranged adjacent to one another, so that both wheels roll uniformly and displacement of the collapsible vehicle is also possible in the collapsed state of the vehicle. For this purpose, it is advantageous to connect the axle of the front wheel to the axle of the rear wheel.

The wheel locking unit can be formed like a bayonet fitting, wherein a wheel locking pin is formed on one of the two wheels, in particular on the at least one rear wheel, and a pin receptacle is formed on the remaining wheel, in particular on the at least one front wheel. The wheel locking unit is accordingly preferably formed as a bayonet fitting. The wheel locking pin is preferably formed cylindrically. It is possible that the wheel locking pin has a double cylinder, wherein a locking contour is formed in the inner cylinder.

The pin receptacle is formed like a funnel, for example. The pin receptacle can have a finding contour. For this purpose, a rounded funnel is formed, so that the wheel locking pin slides in the funnel and/or the wheel locking pin reaches the center of the pin receptacle along the finding contour. At least one locking stud can be formed in the center of the pin receptacle.

It is possible that the pin receptacle and/or parts of the wheel locking unit, in particular the finding contour, is/are coated with a particularly slippery material. The finding contour can be coated using a plastic. Furthermore, it is possible that the finding contour, in particular the funnel-shaped finding contour, consists of plastic. For example, it is possible that in this context high-molecular-weight thermoplastic, in particular polyoxymethylene (POM) is used. The pin receptacle can have a locking stud in the center, which interacts with the locking contour of the wheel locking pin. The wheel locking pin, in contrast, can have a locking key. This locking key is used for rotating the wheel locking pin or parts of the wheel locking pin. The rotation can cause the wheel locking contour to be rotated in relation to a locking stud of the pin receptacle such that it is possible to disengage the bayonet-fitting-type wheel locking unit.

The finding contour of the pin receptacle is preferably designed such that the front wheel can be pivoted in the direction of the rear wheel. In a position of the two wheels approximately parallel to one another, the wheel locking pin is inserted into the finding contour of the pin receptacle. As a result of the finding contour, the wheels can be aligned in a predefined course in relation to one another.

In a further embodiment of the invention, it is possible that the wheel locking unit comprises a suspension shutoff mechanism, in particular a suspension shutoff lever, which effectuates a suspension shutoff of at least one wheel, in particular at least one rear wheel, in the collapsed state of the vehicle.

The suspension shutoff lever can be designed as a simple push lever or pushbutton. Upon application of a corresponding pressure to the suspension shutoff lever, a suspension shutoff of at least one wheel, in particular at least one rear wheel, can be effectuated. For this purpose, the counterpart of the wheel locking unit, i.e., the other part of the wheel locking unit, which is arranged on the further wheel, has a suspension shutoff lever receptacle. Upon snapping of the suspension shutoff lever into the suspension shutoff lever receptacle, a corresponding pressure can be applied to the suspension shutoff lever, so that a suspension shutoff is effectuated.

The suspension shutoff lever is preferably formed on the side of the wheel locking unit which has the wheel locking pin. The suspension shutoff lever receptacle is preferably formed on the side or the element of the wheel locking unit which also comprises the pin receptacle.

In a further embodiment of the invention, it is possible that the suspension shutoff mechanism is formed separately on the collapsible vehicle as a mechanism detached from the wheel locking unit. The functional principle still exists in this context. The suspension shutoff mechanism effectuates a suspension shutoff of at least one wheel. The suspension shutoff of a wheel has the effect that the collapsible vehicle is simple to transport, in particular simple to pull, in the collapsed state. This is because if the front wheel and the rear wheel have different suspensions, a rough running behavior would occur with front and rear wheels arranged parallel to one another.

As a result of the suspension shutoff mechanism, significantly enhanced stability is effectuated during pulling of the collapsed vehicle. Otherwise the collapsed vehicle would wobble or rock when being pulled with one hand.

The wheel locking unit is preferably designed such that the axis of the wheel locking pin extends through the axis of the catch element. The axis of the pin receptacle can also substantially extend through the axle of the corresponding wheel, in particular the front wheel. The wheel locking unit can be unlockable by a lever, in particular a foot lever, formed on at least one of the wheels, in particular on at least one rear wheel. The lever, in particular the foot lever, effectuates a rotation of a locking bar associated with a locking key. The rotation of the locking bar and of the locking key effectuates, for example, a pivot of the wheel locking pin. The wheel locking contour is thus pivoted, so that, for example, a stud of the pin receptacle becomes released/is released and the pin receptacle can be pulled off of the wheel locking pin.

By means of the lever, in particular the foot lever, the wheel locking pin and/or a locking stud and/or one/the locking contour can be designed as rotatable.

In a further embodiment of the invention, it is possible that a wheel locking unit is designed like a magnetic revolver. For this purpose, magnets are arranged both on the front wheel and also on the rear wheel, in particular in the region of the axles of the two wheels, wherein the magnets are arranged alternately with respect to the alignment of the north pole and the south pole of the magnet. The magnets of the wheel locking unit section of the front wheel and the magnets of the wheel locking unit section of the rear wheel are preferably arranged such that when the front wheel is arranged adjacent to the rear wheel, a magnetic force acts between the two wheel locking unit sections and the at least two wheels are locked to one another as a result of the magnetic force.

In this embodiment as well, the wheel locking unit can be unlockable by a lever, in particular a foot lever, formed on one of the wheels, in particular on at least one rear wheel. The lever preferably causes a pivot of the magnets of a wheel locking unit section. A previously acting magnetic attractive force is canceled out by pivoting the magnets of a wheel locking unit section. The magnets of a first wheel locking unit section are repelled from the magnets of the second wheel locking unit section. The wheel locking unit is unlocked in this state.

In a further embodiment of the invention, one of the two wheels, in particular the front wheel, can be fixed with respect to a 0° position. The fixation can be effectuated in particular by an element of the steering unit. In particular, it is possible that folding down a handle of the steering unit fixes the front wheel in the 0° position. In a further embodiment of the invention, it is possible that the 0° position is/becomes fixed by folding down a display device.

It is possible that during the unlocking of the mechanism locking the front frame part and the rear frame part, the at least one front wheel is moved upward in a stroke of, for example, 0.5 to 4 mm, in particular 1 to 2 mm. This stroke is effectuated, for example, in that the front frame part and the rear frame parts are connected to one another by a finding contour in the region of the pedal and/or in the region of a footrest.

In the locked state, the front frame part and the rear frame part are locked in a mechanically tensioned manner. Due to canceling out of the locking, the dropping tension causes the front frame part to be pressed downward. The front frame part is pressed slightly upward by dropping of the tension and/or the actuation of the pedal unlocks the collapsible vehicle and exerts a stroke upward.

The steering unit preferably comprises handlebars having a base, wherein the handlebars comprise:

at least one grip support, which is arranged in an articulated manner on the base and is pivotable from a first support position into a second support position;

a holding device, which is arranged and/or designed such that the holding device is pivotable in an articulated manner from a first holding position into a second holding position, wherein the holding device locks the grip support with the base in the first holding position; and

a blocking device, which is arranged in an articulated manner on the base and is pivotable from a first blocking position into a second blocking position, wherein the blocking device is arranged and/or designed such that the blocking device blocks the holding device in the first blocking position.

The steering unit can comprise fold-down handles as a result of this embodiment. At least one grip support can thus comprise at least one handle.

The handlebars of the steering unit can thus be collapsed in the context of a folding procedure of a vehicle, which results in compact packing dimensions. The handlebars comprise a base, which is preferably fixedly connected to a steering column of the handlebars and has at least one grip support, a holding device, and a blocking device.

In one embodiment, the grip support can have, for example, brake levers or a throttle lever. To prevent unintentional collapsing of the handlebars, the blocking device blocks the holding device, so that the at least one grip support cannot be pivoted when the individual components are located in the corresponding positions. It is provided in this case that during the operation of the vehicle, the at least one grip support is located in the first support position, the holding device is located in the first holding position, and the blocking device is located in the first blocking position. The grip support is therefore prevented from being pivoted during operation, since it is held by the holding device, which is in turn secured by the blocking device. Enhanced safety is thus offered during travel.

However, if the vehicle is not in operation and is to be collapsed, the holding device can be unlocked by pivoting the blocking device, so that the holding device may be pivoted into the second holding position. The at least one grip support can thereupon be pivoted into the second support position. This thus enables very simple folding together or collapsing of the handlebars by means of a few manipulations and can thus also be carried out by one person.

In one embodiment, the at least one grip support can be held at least partially in a formfitting and/or friction-locked manner in the holding device in the first holding position.

If the at least one grip support is held at least partially in a formfitting manner in the holding device in the first holding position, it is thus ensured that it does not deform even under load, so that a high level of stability is ensured.

Furthermore, in one embodiment the holding device can be mounted on the base via a holding joint so it is rotatable about a holding device axis of rotation. Furthermore, in one embodiment the holding device can be mounted on the base via a holding joint so it is rotatable about a holding device axis of rotation.

If the holding device is also arranged via a holding joint on the base, the holding joint is thus an integral component of the base. Enhanced stability of the overall construction is thus ensured. In particular, the stability is enhanced if the holding device locks the at least one grip support, since when the driver exerts pressure on the at least one grip support, high torques act on the holding joint and corresponding forces are transmitted to the base.

In one embodiment, the holding device can be pre-tensioned in the first holding position via a spring element.

In order that the at least one grip support cannot be unintentionally disengaged, the holding device can be pre-tensioned via a spring element in the first holding position. This results in enhanced safety. In addition, it is more comfortable for the driver to operate the holding device if it snaps into the horizontal as a result of the spring upon pivoting of the handle support.

In a completely collapsed state of the collapsible vehicle, the grip supports are also collapsed. The handles are preferably folded downward after pivoting of the front frame part in the direction of the rear frame part. The folding down of at least one handle, in particular the left handle, can additionally induce fixing of the front wheel in a 0° position.

In still a further embodiment of the invention, it is possible that the front frame part and the rear frame part have stabilizing elements formed corresponding to one another in the region of the connecting zone. In other words, it is possible that at least one tenon connection is formed in the partition region of the frame.

For example, at least one tenon can be formed on one of the frame parts, in particular on the rear frame part. At least one mortise can be formed on the other frame part, in particular on the front frame part. In the unfolded state of the vehicle, the at least one tenon engages in the at least one mortise and causes a stabilization of the vehicle in the unfolded state. Multiple tenon connections are preferably formed. The tenon connections preferably have different geometries and dimensions.

In a further embodiment of the invention, the collapsible vehicle can have a handle in the region of the stand device, in particular on the lower side of the footrest. This handle can be actuated, for example, in the collapsed state of the vehicle. The handle can additionally be used as a support. The support is necessary in particular in the collapsed state of the vehicle when the stand device is folded in.

An electric drive is possible as the drive of the collapsible vehicle, in particular the collapsible motor scooter.

The power source, in particular the battery, of the electric drive is preferably detachably anchored in the rear frame part. The battery can be located, for example, in an ergonomically formed battery box. Such an electric drive is a CO2-neutral drive. As a result of the detachable anchoring of the battery or the rechargeable battery, an empty rechargeable battery can be exchanged easily with a charged rechargeable battery. The charging of such a power source or such a rechargeable battery, respectively, is therefore also possible inside a house. It is not necessary for the collapsible two-wheeled vehicle to be charged at a public charging station and/or at a power filling station.

The battery box can preferably have rollers. In a state detached from the vehicle, the battery can be transported by means of the rollers. It is additionally possible that the battery box comprises a grip, in particular a telescoping and/or extendable grip.

The collapsed vehicle can be pulled and/or pushed by means of the grip of the battery box, for example. Moreover, a section of the steering unit, in particular a section of the handlebars, can be used as a grip in the collapsed state of the vehicle.

In summary, the collapsible vehicle according to the invention is a vehicle collapsible in a simple manner. The collapsing can be carried out without a large application of force. The comfort of the collapsible vehicle, in particular the collapsible motor scooter, is not restricted in comparison to known “non-collapsible” vehicles or motor scooters with respect to the dimensioning of the wheels and/or the steering unit.

The invention will be described hereafter on the basis of exemplary embodiments, which are explained in greater detail on the basis of figures.

In the figures:

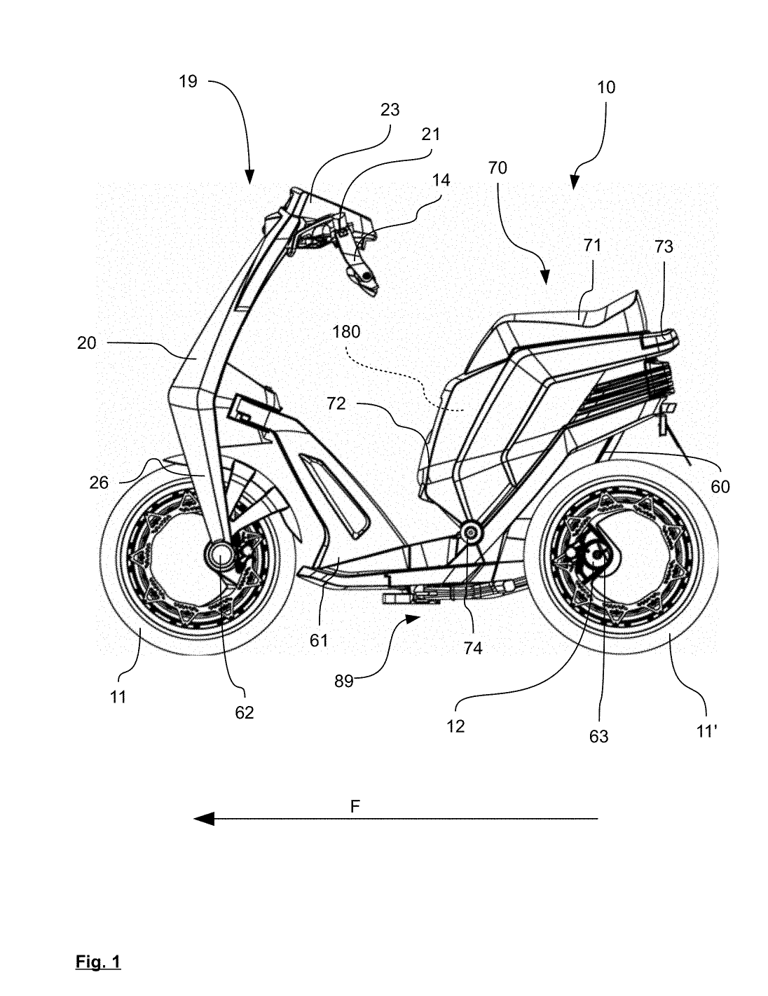

FIG. 1: shows a side view of an unfolded motor scooter;

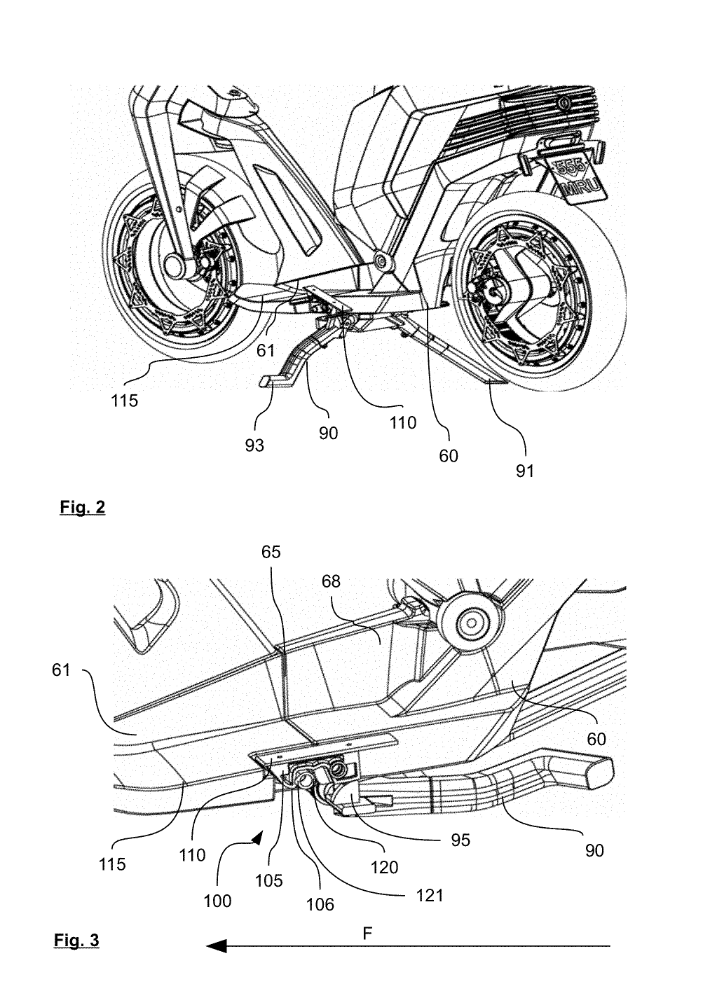

FIG. 2: shows a perspective view diagonally from the rear in a parked and/or elevated state of the motor scooter;

FIG. 3: shows a detail view of the latched foot pedal;

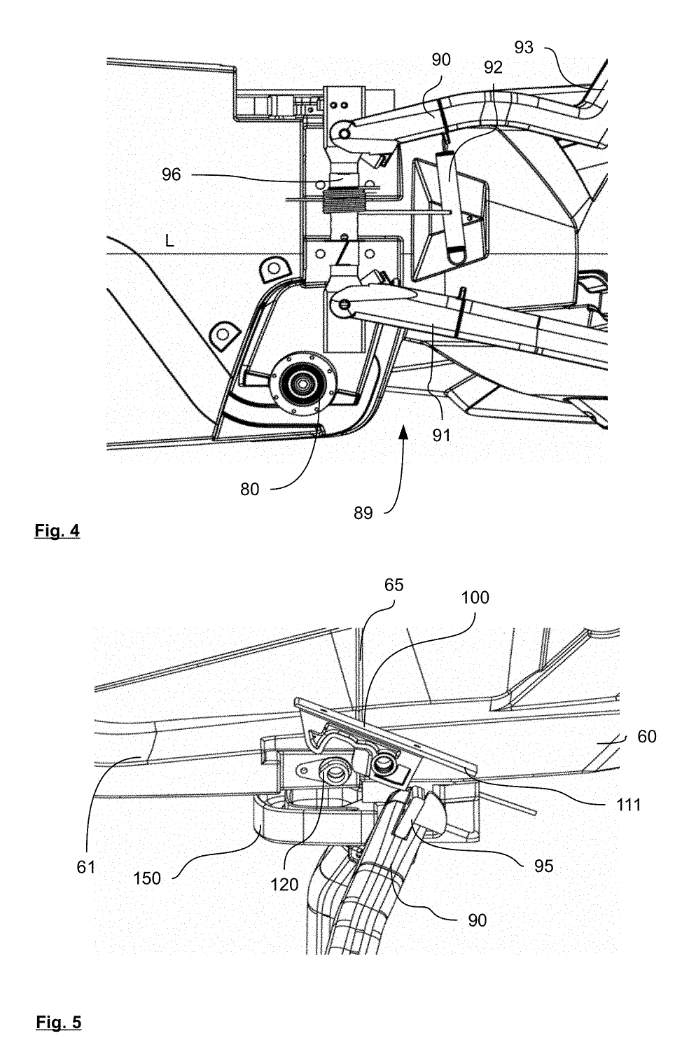

FIG. 4: shows a bottom view of the stand device in the folded-in-state;

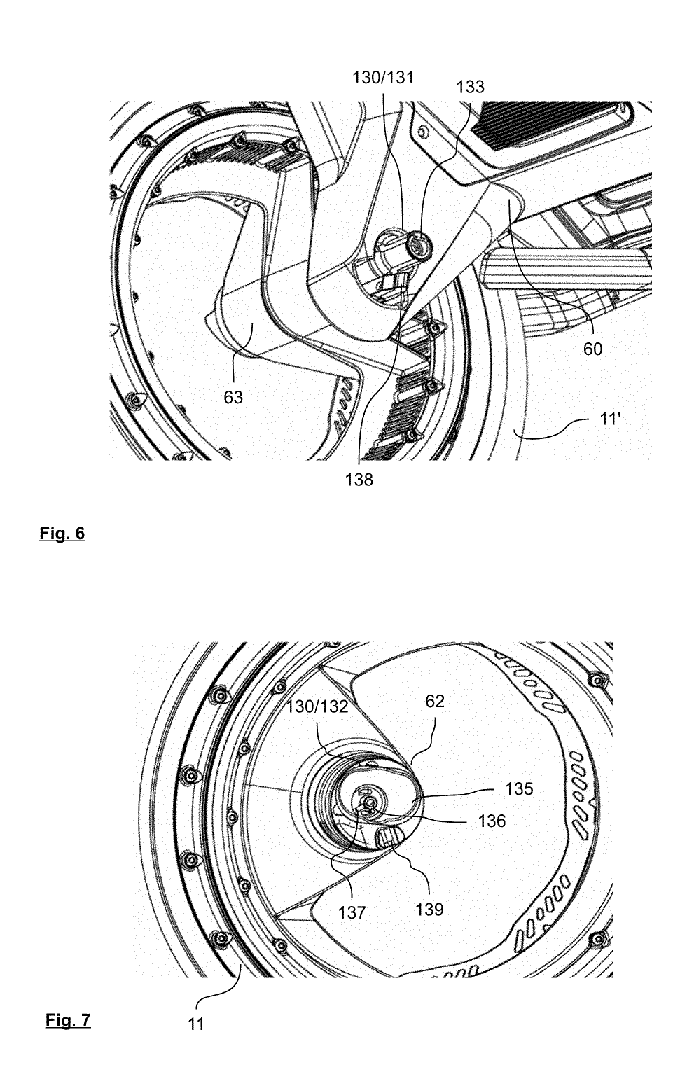

FIG. 5: shows a detail view of the locked pedal;

FIGS. 6 and 7: show detail views of the wheel locking unit;

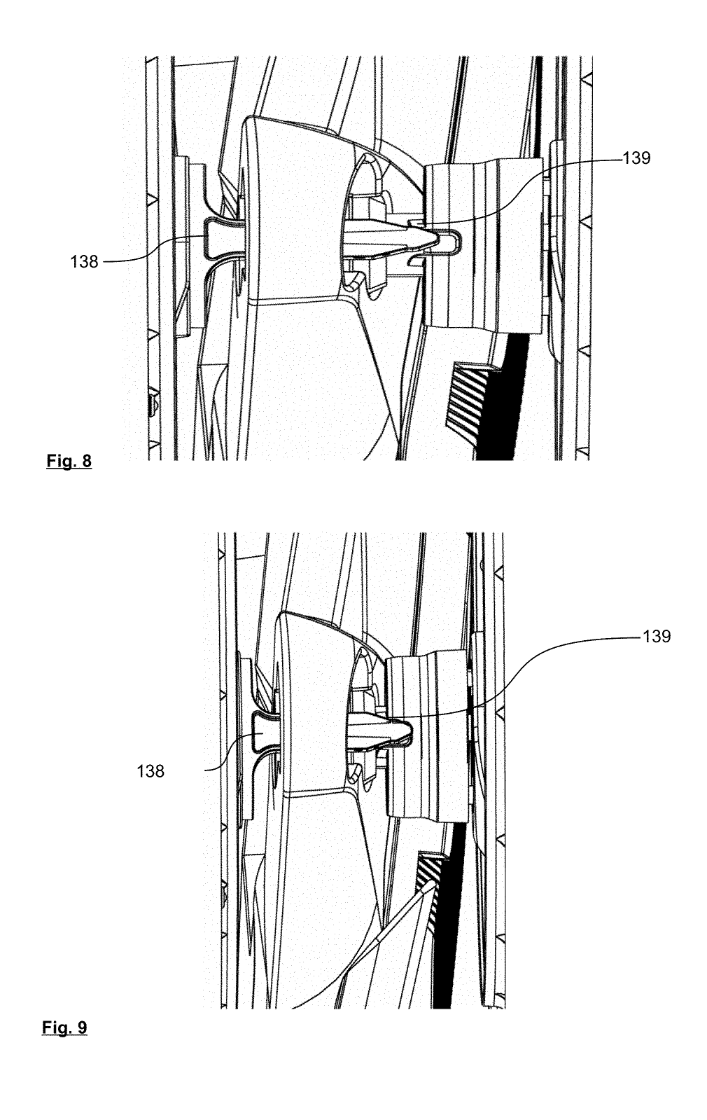

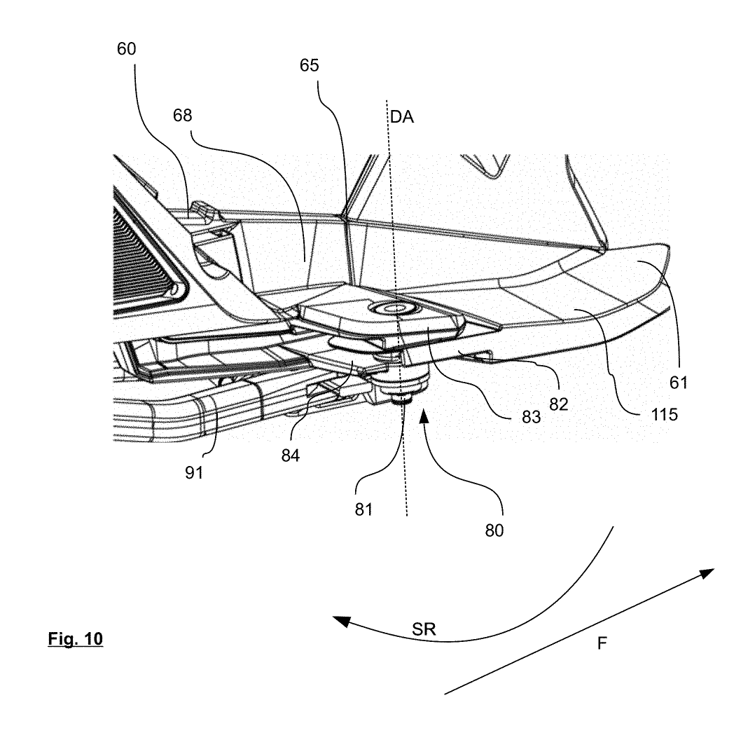

FIGS. 8 and 9: show detail views of the suspension shutoff mechanism;

FIG. 10: shows an illustration of the pivot joint;

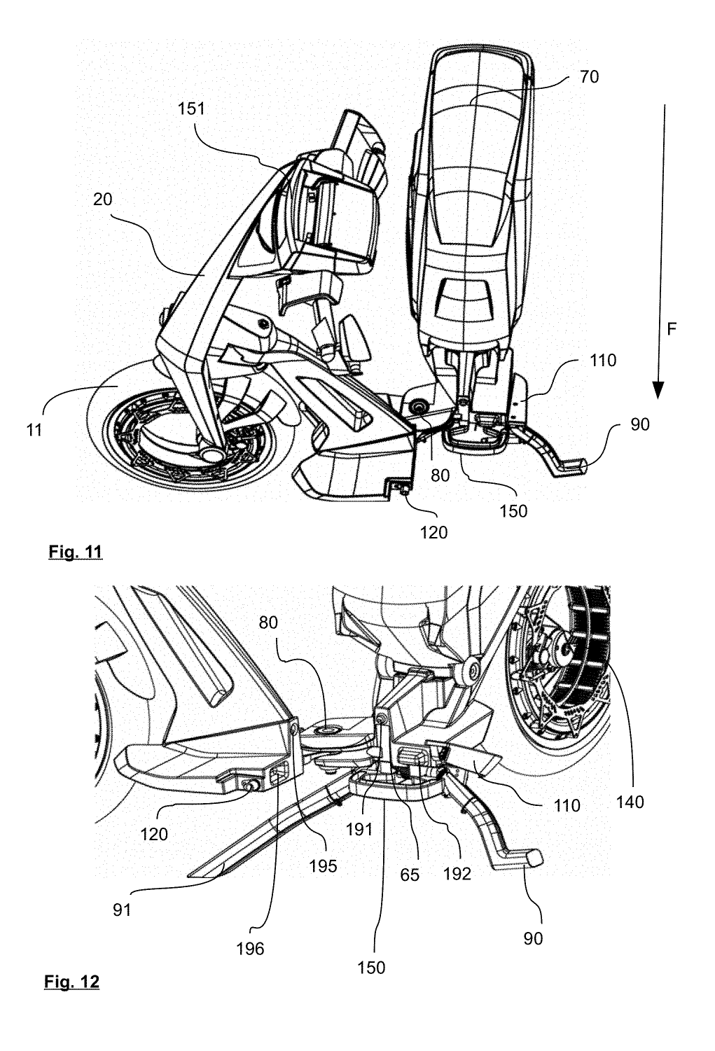

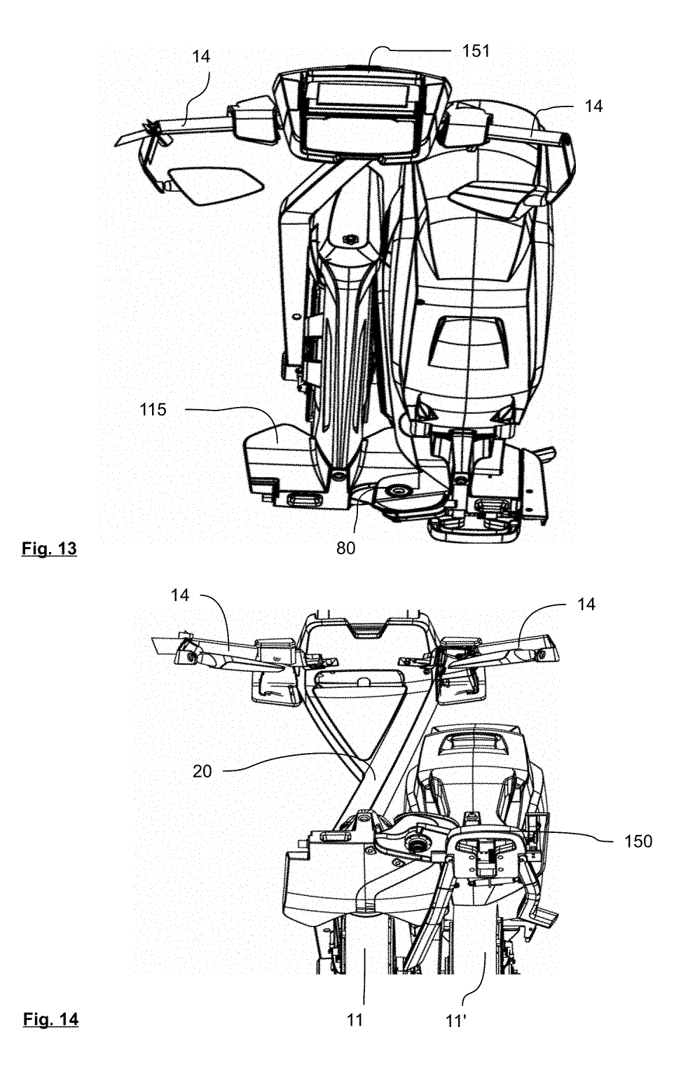

FIGS. 11 and 12: show illustrations of the partially-collapsed state of the vehicle;

FIGS. 13 and 14: show illustrations of the completely collapsed vehicle;

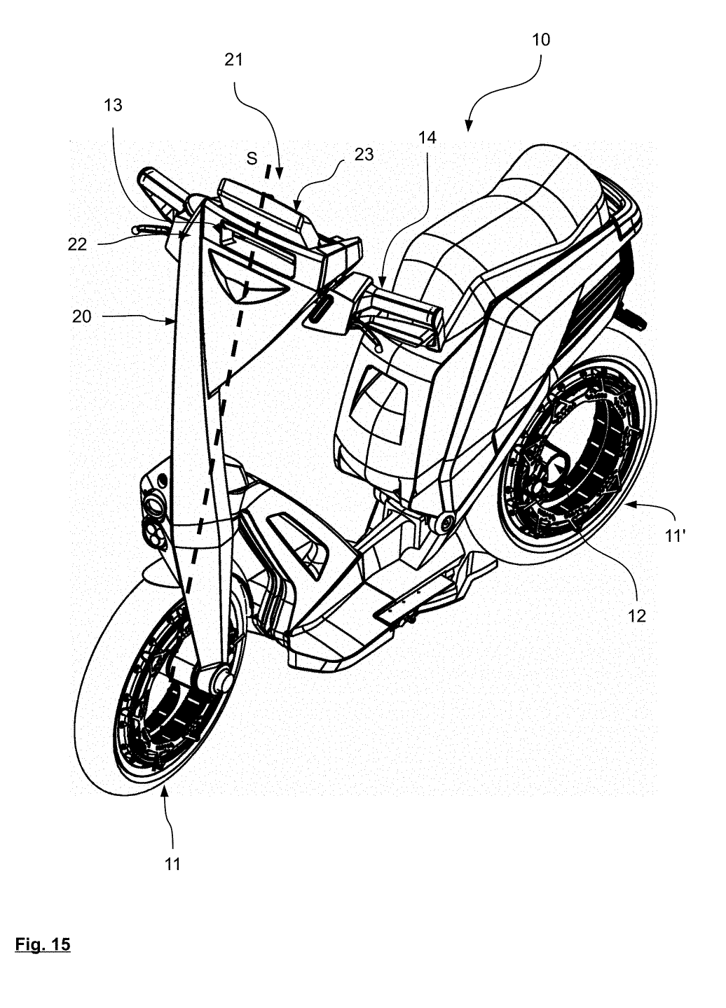

FIG. 15: shows an illustration of a travel-ready vehicle having a display unit;

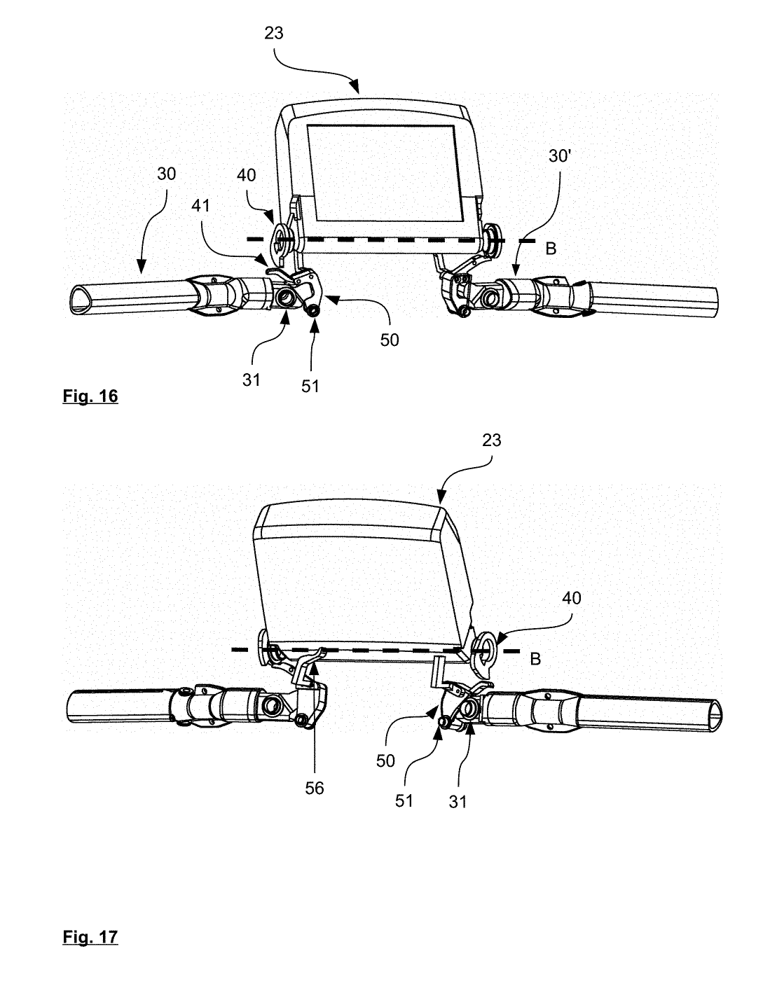

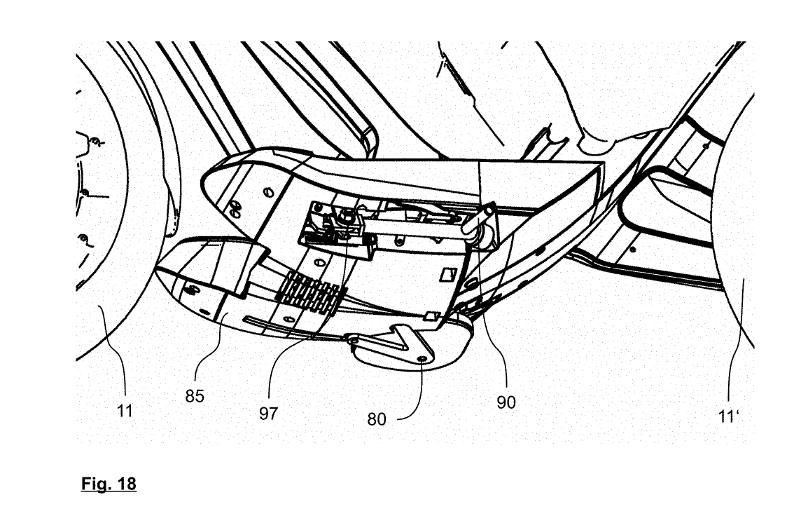

FIGS. 16 and 17: show illustrations of individual mechanical parts of the handlebars; and

FIG. 18 shows a perspective illustration of a further embodiment of the vehicle with different stand device.

In the following description, the same reference signs are used for identical and identically acting parts.

FIG. 1 shows a vehicle 10 according to the invention in the unfolded state. The vehicle 10 shown is a two-wheeled vehicle, in particular a motor scooter. The motor scooter 10 has a rear frame part 60 and a front frame part 61. The rear frame part 60 bears the rear wheel 11′ and the seat unit 70. The front frame part 61 bears the steering unit 19 including the front wheel 11.

The steering unit 19 comprises handlebars 21, a steering column 20, and a rocker arm 26 connected to the steering column 20. Operating elements, for example, a horn and also the handles 14 can be arranged on the handlebars 21. Furthermore, the handlebars 21 can have a display unit 23, which displays, for example, the travel speed or the charge state of a battery. The display 23 is folded in in the example illustrated in FIG. 1.

The seat unit 70 comprises a saddle 71, a battery box 72, an extendable and/or telescoping grip 73, and rollers 74. The seat unit 70 accordingly comprises a battery 180, which is used for the electrical supply of the drive unit 12, inside the battery box 72. The seat unit 70 can be detached from the rear frame part 60, so that the seat unit 70, including the battery 180 located therein, can be separately pushed or pulled with the aid of the grip 73. Furthermore, the collapsible motor scooter 10 comprises a stand device 89. However, in the illustrated example, the stand device 89 is not actuated.

As can be seen in FIG. 2, the stand device 89 comprises two side stands 90 and 91. The left side stand 90 is shorter than the right side stand 91 in this case. The left side stand 90 has a lever section 93. The two side stands 90 and 91 are preferably mechanically coupled to one another, so that an actuation of the left side stand 90 on the lever section 93 effectuates an actuation of the right side stand at the same time. In FIG. 2, the footrest 115 can furthermore be seen. The footrest 115 also consists of a left and a right section, so that both feet of the driver can be placed comfortably on the motor scooter 10. A pedal 110 in a partially actuated state can also be seen. The interaction of the pedal 110 with the stand device 89, in particular with the left side stand 90, is illustrated in greater detail in FIGS. 3 to 5.

The left side stand 90 is folded up and/or not actuated in FIG. 3. Accordingly, as a result of the mechanical coupling of the two side stands 90 and 91, the right side stand 91 (not shown) is also folded up. As a result of a stop element 95 formed on the left side stand 90, a force acts from below on the pedal 110. The pedal 110 cannot be actuated in this state. The stop element 95 blocks the pedal 110. The pedal 110 is fastened on the rear frame part 60 and causes a connection of the rear frame part 60 to the front frame part 61. The partition region 65 between the rear frame part 60 and the front frame part 61 can also be seen. The partition region 65 is formed both in the footrest 115 and also in the center strut 68.

The pedal 110 is part of a mechanism 100, which can lock the front frame part 60 and the rear frame part 61 with one another. The mechanism 100 comprises a locking hook 105 and a locking pin 120. The locking hook 105 is formed as part of the pedal 110. The locking hook 105 has a locking contour. The locking pin 120, in contrast, is formed on the front frame part 61. Upon an actuation of an unlocked pedal 110, the lug 106 of the locking hook 105 can slide along the contour 121 of the locking pin 120 until the locking hook 105 is completely free.

The stand device 89 is shown in a bottom view in FIG. 4. The left side stand 90 and the right side stand 91 can be seen. The left side stand 90 is connected to the right side stand 91 via a linkage 96. Moreover, a spring 92 can be seen. The side stand 90, which is shorter in comparison to the side stand 91, can be tensioned upon folding out with the aid of this spring 92. Furthermore, the pivot joint 80 can be seen in FIG. 4. In conjunction with the longitudinal axis L of the motor scooter 10, the relationship results with respect to the side stands 90 and 91 that the two side stands 90 and 91 are arranged asymmetrically in relation to one another. The right side stand 91 is not only longer than the left side stand 90 but rather also has a different shape and a different fastening angle. The pivot joint 80 is formed on the right side in relation to the longitudinal axis L of the vehicle. An acentric arrangement of the pivot joint 80 results. The pivot joint 80 is not formed on the longitudinal axis L, but rather spaced apart from the longitudinal axis L.

The folded-out side stand 90 is shown in FIG. 5. As can be seen, the stop element 95 is pivoted such that the pedal 110 can be moved. By pressing the rear section 111 of the pedal 110 in the direction of the stop element 95 and/or downward, the locking hook 105 can be released such that the locking pin 120 is no longer connected to the locking hook 105. The locking pin 120 located on the front frame part 61 is released, so that the front frame part 61 can be separated at least in sections from the rear frame part 60.

If the locking mechanism 100 is disengaged, the front frame part 60 can be folded in the direction of the rear frame part 61. To be able to guide the two wheels, namely the front wheel 11 and the rear wheel 11′, comfortably adjacent to one another, the vehicle, in particular the motor scooter 10, has a wheel locking unit 130. The individual parts of the wheel locking unit 130 are shown in FIGS. 6 and 7.

The rear wheel 11′ and the rear frame part 60 are shown in FIG. 6.

In contrast, the front wheel 11 and the element of the wheel locking unit 130 associated therewith are shown in FIG. 7. The wheel locking unit 130 effectuates a connection of the axle 62 of the front wheel 11 to the axle 63 of the rear wheel 11′.

The wheel locking unit 130 is formed like a bayonet fitting. A wheel locking pin 131 is formed on the rear wheel 11′ and a pin receptacle 132 is formed on the front wheel 11. The wheel locking pin 131 is formed as a double cylinder and has a locking contour 133 in the interior. The wheel locking pin 131 is guided into the pin receptacle 132 of the front wheel 11 upon pivoting back of the front wheel 11 and/or the front frame part 61. For this purpose, the pin receptacle 132 has a finding contour 135. The finding contour 135 is preferably specially coated, so that the wheel locking pin 131 can slide along the finding contour 135 in the direction of the center 136 of the pin receptacle 132.

The finding contour 135 is formed like a funnel. The funnel is preferably sufficiently large that the wheel locking pin 131 can slide comfortably in the direction of the center 136. The pin receptacle 132 moreover has a stud 137, which can engage in the locking contour 133 of the wheel locking pin 131. If the wheel locking unit 130 is completely locked, the two wheels 11 and 11′ can be pushed together and/or pulled together comfortably adjacent to one another.

The wheel locking unit 130 furthermore comprises a suspension shutoff mechanism, in particular a suspension shutoff lever 138, which effectuates a suspension shutoff of at least one wheel, in particular the rear wheel 11′, in the collapsed state of the vehicle 10. The suspension shutoff lever 138 can be formed as a simple push lever. Upon application of a corresponding pressure to the suspension shutoff lever 138, the suspension shutoff of the wheel 11′ is effectuated. For this purpose, the counterpart of the wheel locking unit 130, i.e., the front part of the wheel locking unit 130, has a suspension shutoff lever receptacle 139. Upon snapping of the suspension shutoff lever 138 into the suspension shutoff lever receptacle 139, a corresponding pressure can be applied to the suspension shutoff lever 138, so that a suspension shutoff is effectuated. The suspension shutoff lever receptacle 139 also has an indicated finding contour, so that the suspension shutoff lever 138 can slide easily into the suspension shutoff lever receptacle 139.

Various positions of the suspension shutoff lever 138 are shown in FIGS. 8 and 9. In the state shown in FIG. 9, the suspension shutoff lever 138 is snapped completely into the suspension shutoff lever receptacle 139. FIG. 8 shows that the suspension shutoff lever 138 can slide out along the finding contour of the suspension shutoff [lever] receptacle 139.

The pivot joint 80 is shown in greater detail in FIG. 10. The pivot joint 80 is formed in the travel direction F on the right side of the footrest 115 and/or on the right of the center strut 68. The pivot joint 80 is formed in the nature of a hinge joint, wherein a hinge pin 81 connects a plate section 82 of the front frame part 61 and plate sections 83 and 84 of the rear frame part 60 to one another so they are rotatable. If the stand device 89 is folded out, it is apparent that the longer side stand 91 determines the pivot direction SR of the front frame part 61 in the direction of the rear frame part 60. The axis of rotation DA of the pivot joint 80 extends substantially or approximately perpendicularly in relation to the parking surface of the vehicle 10.

The vehicle, in particular the motor scooter 10, is shown in the partially collapsed state in FIGS. 11 and 12. The mechanism 100 is unlocked, so that the front frame part 61 can be pivoted in the direction of the rear frame part 60 in the pivot direction SR about the axis of rotation DA of the pivot joint 80. It can also be seen in the figures that multiple tenon connections are formed in the partition region 65. The rear frame part 60 has a first conical tenon 191 and a second approximately cuboid tenon 192 for this purpose. Mortises 195 and 196 are formed complementary thereto in the front frame part 61. The tenon connections have a stiffening effect in the unfolded and locked state of the motor scooter 10. If the tenon connections were not formed, only a fastening via the partition plane 65 through the pedal 110 would be provided.

Furthermore, a grip 150 can be seen, which is formed in the region of the stand device 89. The grip 150 can form a storage option in the completely collapsed state of the vehicle, as shown in FIGS. 13 and 14.

The stand device 89 is folded in in FIGS. 13 and 14. The stand device 89 can be folded in because of the spring 92 (see FIG. 4 in this regard). Lifting up the collapsed vehicle 10 results in automatic folding in of the stand device 89. To nonetheless form a storage surface, the grip 150 is formed in the region of the stand device 89. In the state shown in FIGS. 13 and 14, the handles 14 are not yet folded in. These can also be folded in.

Parts of the steering unit 19 can also be formed as a grip. The section 151 is formed for this purpose. A grip is formed with the aid of the section 151, so that the collapsed vehicle can be pulled with the wheels 11 and 11′ arranged adjacent to one another. By connecting the axles 62 and 63 of the front wheel 11 and the rear wheel 11′, the two wheels 11 and 11′ are formed parallel and congruent in relation to one another. The collapsed scooter 10 can be pushed and/or pulled in a simple manner.

If the motor scooter is to be unfolded, firstly the wheel locking unit 130 is to be disengaged. This is preferably performed by actuating the foot lever 140 (see FIG. 12). The foot lever 140 effectuates a pivot of a part of the wheel locking unit 130. The bayonet-fitting-type wheel locking unit 130 can then be separated, so that the front wheel 11 can be pivoted away from the rear wheel 11′ about the axis of rotation DA.

A completely travel-ready motor scooter 10 is shown in FIG. 15. The display unit 23 is folded up in this case. A connection to the drive unit 12 can be produced by folding up the display unit 23. It is possible that the power supply of the drive unit 12 is interrupted by folding down the display unit 23. In this case, the folding down of the display unit 23 results in the actuation of a switch, which is arranged between the display unit 23 and an operating panel located underneath. The switch transmits a signal to a control device upon actuation, which in reaction thereupon interrupts the power flow from the battery 180 to the drive unit 12. Another signal is transmitted to the control device by folding up the display unit 23. This signal causes a power flow to be established from the battery 180 to the drive unit 12 in the folded-up state of the display unit 23.

The handlebars 21 are shown in greater detail in conjunction with FIGS. 15, 16, and 17. The handlebars 21 are fixedly installed on the steering column 20, which can be pivoted about a pivot axis S, and the handlebars 21 comprise a base 22 and handles 14. The handles 14 are arranged on grip supports 30, 30′ on the base 22. The driver of the motor scooter 10 can control various functions of the motor scooter 10 via the handles 14, for example, horn, turn signals, braking, or acceleration. The handle supports 30, 30′ are each alternately articulated with the base 22. An actuating opening 13 is provided in the front region of the motor scooter 10 on the handlebars 21, so that the handle 151 can be formed. The driver can reach into the actuating opening 13, so that the actuating opening 13 and/or the grip 151 can be used for pulling the motor scooter 10 in the collapsed state. The driver can reach an actuating lever 56 by reaching through the actuating opening 13 and disengage a locking of the handles 14 and thus collapse the handlebars 21.

FIGS. 16 and 17 are detail views of important mechanical parts of the handlebars 21, wherein paneling parts and the base 22 are not shown for the illustration of the functionality of the locking.

The display unit 23 is shown in the folded-up position, wherein a blocking device 40 is arranged laterally on the display unit 23. The display unit 23 and the blocking device 40 are both mounted so they are rotatable on a shaft about the display axis of rotation B. The display unit 23 and the blocking device 40 can thus only be pivoted together in this exemplary embodiment. Furthermore, FIG. 16 shows two grip supports 30, 30′, which are each arranged laterally below the display unit 23. The grip supports 30, 30′ are pivotably connected to the base 22 so they are rotatable on support joints 31. The grip supports 30, 30′ are locked by a holding device 50. The holding device 50 is connected to the base 22 via a holding joint 51 so it is pivotable. The grip supports 30, 30′ can be produced from a plurality of materials and a plurality of configurations. In the illustrated exemplary embodiment, the grip supports 30, 30′ are formed as hollow tubes made of fiber composite material. In further exemplary embodiments, the grip supports 30, 30′ are formed, for example, as hollow aluminum or magnesium tubes. Light construction materials are preferably used, in order to reduce the weight and thus have a positive effect on the power consumption of the motor scooter 10.

FIG. 17 shows parts of the handlebars 21 of FIG. 16 in a schematic front view. In particular, FIG. 17 shows that the holding device 50 can be pivoted via actuating lever 56. In this case, the actuating lever 56 represents the element which the driver has to actuate to collapse the handlebars 21. As can be seen clearly from FIGS. 16 and 17, however, it is not possible for the driver to actuate this lever while the display unit 23 is located in a folded-up position. In the mentioned case, the blocking device 50 blocks blocking levers 41, which are connected to the holding device 50.

FIG. 18 shows a detail of a further exemplary embodiment of the motor scooter 10 in a bottom view. FIG. 18 shows that the stand device has a side stand 90, which is fastened so it is pivotable on the front frame part 61 via a stand joint 97. To park the motor scooter 10, the side stand 90 can be folded out, so that the front wheel 11, the rear wheel 11′, and the side stand 90 form support points which hold the motor scooter 10 stably.

To collapse the motor scooter 10 of FIG. 18, the locking between rear frame part 60 and the front frame part 61 is disengaged as described by actuating the foot lever 110. The handlebars 21 and/or the steering column 20 are subsequently pivoted such that the front wheel 11 assumes an angle of more than 90° with respect to the vehicle longitudinal axis. The front wheel 11 can now be pivoted about the pivot joint 80.

Up to an angle of 90°, preferably 100°, between front frame part 61 and rear frame part 60 (first rotation phase), the motor scooter 10, as described, is held stably by the front wheel 11, the rear wheel 11′, and the side stand 90.

From an angle of greater than 90°, preferably 110°, between front frame part 61 and rear frame part 60, the front wheel 11 loses contact with the ground and the motor scooter 10 is held stably by the rear wheel 11′, the side stand 90, and a support point 85 on the foot pedal 110. Because the front wheel 11 now hangs freely movable in the air, the handlebars 21 and/or steering column 20 are freely movable. The front wheel 11 can now be aligned on the longitudinal axis of the front frame part 61. The front wheel 11 and the rear wheel 11′ are then arranged at least substantially parallel to one another, so that they can be locked to one another as described.

To unfold the motor scooter 10, the method described with reference to FIG. 18 is executed in reverse, wherein the handlebars 21 and/or the steering column are pivoted in the opposite direction.

Alternatively, embodiments are conceivable in which the blocking device 40 is formed as a blocking disk. A blocking disk is not formed rotationally-symmetrical, but rather has a region which has a protrusion. The region of the protrusion is formed reinforced in this case, to take into consideration an elevated load on the protrusion. A blocking disk can block a pivot of the blocking lever 41 and thus also a pivot of the holding device 50.

It is to be noted at this point that all above-described parts are claimed as essential to the invention considered alone and in any combination, in particular the details illustrated in the drawings. Modifications thereof are routine for a person skilled in the art.

### LIST OF REFERENCE SIGNS

10 motor scooter
11 front wheel
11′ rear wheel
12 drive unit/electric motor
13 actuating opening
14 handle
19 steering unit
20 steering column
21 handlebars
22 base
23 display unit
26 rocker arm
30, 30′ grip support
31 support joint
40 blocking device
41 blocking lever
50 holding device
51 holding joint
56 actuating lever
60 rear frame part
61 front frame part
62 axle of front wheel
63 axle of rear wheel
65 partition region
68 center strut
70 seat unit
71 saddle
72 battery box
73 handle
74 roller
80 pivot joint
81 tenon
82, 83, 84 plate section
85 support point
89 stand device
90 left side stand
91 right side stand
92 spring
93 lever section
95 stop element
96 linkage
97 stand joint
100 locking mechanism
105 locking hook
106 lug
110 pedal
111 rear section
115 footrest
120 locking pin
121 contour
130 wheel locking unit
131 wheel locking pin
132 pin receptacle
133 locking contour
135 finding contour
136 center
137 pin
138 suspension shutoff lever
139 suspension shutoff lever receptacle
140 foot lever
150 grip
151 grip
180 battery
191, 192 tenon
195, 196 mortise
B display axis of rotation
DA axis of rotation
L longitudinal axis of vehicle
S pivot axis
SR pivot direction

1. A collapsible vehicle comprising:
a rear frame part bearing a seat unit and at least one rear wheel and a front frame part bearing a steering unit and at least one front wheel, wherein;
the front frame part and the rear frame part are connected to one another via an acentric pivot joint such that during collapsing of the vehicle, at least one frame part is pivotable such that the at least one front wheel and the at least one rear wheel are arranged adjacent to one another.

2. The collapsible vehicle according to claim 1,
characterized by
a stand device, which comprises at least two side stands.

3. The collapsible vehicle according to claim 2,
characterized in that
the at least two side stands are arranged asymmetrically in relation to one another and have different lengths and are mechanically coupled to one another, via a linkage.

4. The collapsible vehicle according to claim 2,
characterized in that
the stand device is connected to a spring, which can be tensioned upon folding out of the stand device.

5. The collapsible vehicle according to claim 1,
characterized in that
a mechanism locking the front frame part and the rear frame part in the unfolded state comprises a locking hook and can be actuated by a pedal, wherein the pedal is formed as a section of a footrest of the vehicle.

6. The collapsible vehicle according to claim 5,
characterized in that
the pedal is unlockable by means of one of the side stands.

7. The collapsible vehicle according to claim 5,
characterized in that
the locking hook is formed on the pedal and a locking pin is formed on the front frame part.

8. The collapsible vehicle according to claim 3,
characterized in that
the longer side stand determines the pivot direction of the front frame part in the direction of the rear frame part.

9. The collapsible vehicle according to claim 1,
characterized in that
the front wheel and the acentric pivot joint are arranged in relation to one another such that the front wheel is pivotable along a circular path about the acentric pivot joint.

10. The collapsible vehicle according to claim 1,
characterized in that
the rear wheel, the stand device, and at least one section of a footrest, including the pedal are arranged such that and designed for forming the only support points of the vehicle at least in sections during collapsing of the vehicle during a first rotation phase.

11. The collapsible vehicle according to claim 10,
characterized in that
the rear wheel, the stand device, and at least one section of the footrest, including the pedal are arranged such that and designed for forming the only support points of the vehicle in a second rotation phase chronologically following the first rotation phase during collapsing.

12. The collapsible vehicle according to claim 2,
characterized in that
the stand device is connected to the front frame part via a stand joint.

13. The collapsible vehicle according to claim 1,
characterized in that
an axle of the front wheel is connected or connectable to an axle of the rear wheel by means of a wheel locking unit in the collapsed state of the vehicle.

14. The collapsible vehicle according to claim 13,
characterized in that
the wheel locking unit is formed like a bayonet fitting and a wheel locking pin is formed on one of the two wheels and a pin receptacle is formed on the remaining wheel.

15. The collapsible vehicle according to claim 14,
characterized in that
the pin receptacle has a finding contour.

16. The collapsible vehicle according to claim 13,
characterized in that
the wheel locking unit comprises a suspension shutoff mechanism including a suspension shutoff lever, which, in the collapsed state of the vehicle, effectuates a suspension shutoff of at least one wheel.

17. The collapsible vehicle according to claim 13,
characterized in that
the wheel locking unit is unlockable by a lever comprising a foot lever, formed on one of the wheels.

18. The collapsible vehicle according to claim 17,
characterized in that
the wheel locking pin and/or a locking stud and/or a locking contour is rotatable by means of the lever.

19. The collapsible vehicle according to claim 1,
characterized in that
the steering unit comprises handlebars having a base, wherein the handlebars comprise:
at least one grip support, which is arranged in an articulated manner on the base and is pivotable from a first support position into a second support position,
a holding device, which is arranged and/or designed such that the holding device is pivotable in an articulated manner from a first holding position into a second holding position, wherein the holding device locks the grip support to the base in the first holding position, and
a blocking device, which is arranged in an articulated manner on the base, and is pivotable from a first blocking position into a second blocking position, wherein the blocking device is arranged and/or designed such that the blocking device blocks the holding device in the first blocking position.

20. The collapsible vehicle according to claim 1,
characterized in that
the vehicle is drivable using an electric drive.

21. The collapsible vehicle according to claim 20,
characterized in that
a power source of the vehicle is a battery of the electric drive and is detachably anchored on the rear frame part.
